(19) United States
(12) Patent Application Publication
(10) Pub. No.: US 2024/0125402 A1
(43) Pub. Date: Apr. 18, 2024

(54) Contamination-Resistant Throttle Valve

(71) Applicant: Daniel Gelbart, Vancouver (CA)

(72) Inventor: Daniel Gelbart, Vancouver (CA)

(21) Appl. No.: 17/966,819

(22) Filed: Oct. 15, 2022

(51) Int. Cl. F16K 25/00

(52) U.S. Cl. CPC F16K 25/005

(57) ABSTRACT

A throttle valve creates the equivalent of a small orifice by using a much larger orifice which is turned on and off periodically, creating a flow equivalent to a much smaller orifice. The ratio of on time to off time is changed to create the desired effective orifice. By using an elastomeric member to form the orifice seal, solid particles do not interfere with the operation of the valve.

### FIELD OF THE INVENTION

The invention relates to vacuum systems and in particular to vacuum systems used in sintering furnaces requiring a throttle valve to control the vacuum level.

### BACKGROUND OF THE INVENTION

In certain vacuum systems, like the ones used in sintering furnaces, a throttle valve is used between the vacuum pump and the sintering chamber, or retort. The purpose of this valve is to prevent the chamber pressure from going too low. Many types of vacuum pumps, such as oil filled pumps, have to run at a constant speed to assure proper lubrication, so vacuum level can not be controlled by changing pump speed. Such pumps rely on a throttle valve having a small opening to control the effective pumping rate. Such valves can be manual or motorized needle valve, slide valve etc. When used in sintering furnaces these valves tend to get plugged by the contamination produced during the sintering process, mainly the decomposition of the binders. Unlike pressurized valves, these valves can not “self clean” as the vacuum exerts negligible forces on the contaminants. For small sintering furnaces the throttle valve has an equivalent orifice diameter from 0.1 to 1 mm, so it is very likely to get plugged by either tar-like debris or by solid particles. Sometimes on/off modulation is used to create an equivalent small opening from a larger opening, but these valves can plug as well. The invention overcomes this problem in an effective method, not only eliminating valve plugging but providing a self cleaning throttle valve.

### SUMMARY OF THE INVENTION

A throttle valve creates the equivalent of a small orifice by using a much larger orifice which is turned on and off periodically, creating a flow equivalent to a much smaller orifice. The ratio of on time to off time is changed to create the desired effective orifice. By using an elastomeric member to form the orifice seal, solid particles do not interfere with the operation of the valve.

### BRIEF DESCRIPTION OF THE DRAWINGS

FIG. 1 shows the preferred embodiment of the invention.

FIG. 2 is a diagram showing the principle of changing the effective flow rate by changing the on/off ratio.

FIG. 3 shows a cross-section of an embodiment of the invention for use with explosive gases.

### DESCRIPTION OF THE PREFERRED EMBODIMENT

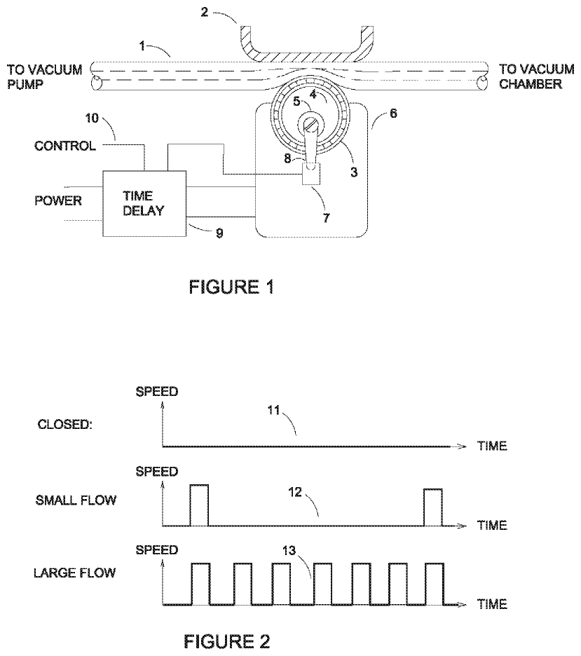

Referring to FIG. 1, a flexible rubber hose 1 is compressed between a rotating eccentric cam 4 and a fixed support 2. Cam 4 is placed inside a ball bearing 3 in order to avoid sliding contact between the cam and hose 1. When cam 4 rotates the outside of bearing 3 does not rotate, therefore the hose does not wear out. Bearing 3 can be a ball, roller or sleeve bearing. A gear motor 6 having a shaft 5 is rotating the cam. The rotation rate of shaft 5 is typically between 1 and 100 RPM. Lower rotation rates increase the pressure variations but reduce the required power and wear. The on/off mode of operation of this valve causes pressure fluctuations. The rotation rate is selected by the maximum pressure fluctuations that can be tolerated. A time delay unit 9 controlled by an external signal 10 changes the delay time between rotations. During a rotation the cam 4 changes the compression of tube 1 allowing it to be fully open, or nearly so, once per rotation before returning to a sealed off position due to compression. In order to synchronize the position of cam 4 and the control signal, a position detector is used. This can be as simple as an optical interrupter (also known as a photo-interrupter) 7 and a light blocking arm 8. At the end of a rotation the cam will stay in the position shown in the drawing, pinching-off tube 1. After a controlled delay, shaft 5 will rotate another full rotation and return again to the position shown.

Motor 6 is preferably of the brushless DC type, but any type of motor can be used such as a geared AC motor or a stepper motor. When a stepper motor is used, no gearing is required as the motor can be rotated at very low speeds.

The embodiment shown in FIG. 1 also has the advantage of self-cleaning. Most of the contaminants in a sintering process condense as a thick liquid or paste. Because hose 1 is fully squeezed once per rotation, the contaminants are pushed out of the way, into the large opening of the hose. Solid particles get pushed into the elastomeric hose 1 and do not interfere with creating a vacuum-tight seal. The preferred hose material is natural rubber.

In the preferred embodiment the hose 1 is a 3/16″ ID× 9/16″ OD gum rubber hose available from McMaster Carr. Motor 6 is a 60 RPM brushless DC gearmotor. Time delay 9 is a simple RC circuit or a digital timer, and control signal 10 can be digital or analog. Bearing 3 is a 28 mm OD ball bearing and the total travel of the cam is 5 mm. When such a valve was connected between an oil filled vacuum pump and a furnace having a volume of 30 liter and an incoming gas flow of 0.5 LPM, it controlled the pressure accurately from 1% of atmospheric pressure to atmospheric pressure.

Referring now to FIG. 2, when the motor is not rotating there is no flow in tube 1. This is shown by graph 11. As the motor rotates intermittently, the periodic opening of the tube create a pulsating flow with an average flow matching a certain orifice size. This is shown in graph 12, showing motor speed vs. time. When the motor rotates continuously, as shown in graph 13, the largest equivalent orifice is created.

It is clear that compressing a rubber hose with a cam is just one of many ways to implement the invention. Motor 6 can be replaced by an air cylinder, electric solenoid, hydraulic actuator and any other actuator. Hose 1 can be replaced by a motorized needle valve, sliding valve or any other type of valve. The combination if hose 1 and motor 6 can be replaced by a solenoid valve, however this is less desirable because it is less effective in self-cleaning. The important part of the invention is to be able to seal both against paste-like (thick liquid) contamination and against solid particles, and be self cleaning.

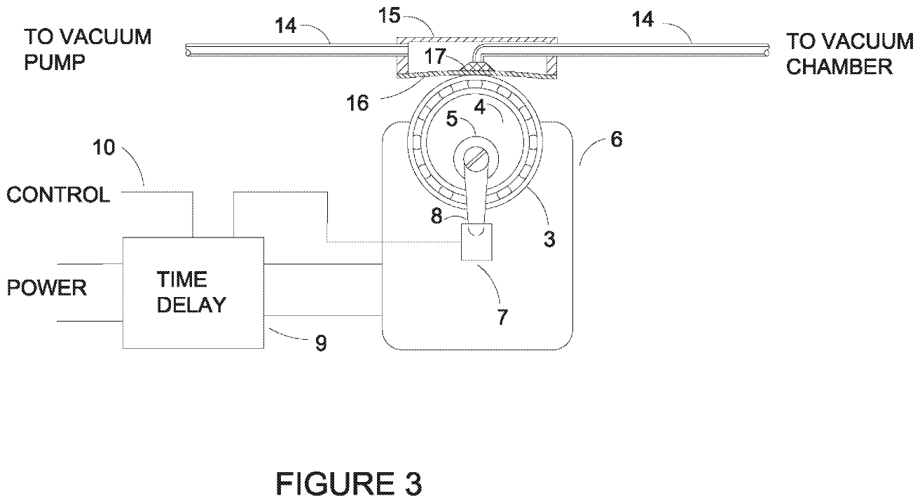

An embodiment suitable for use with explosive or highly corrosive gases is shown in FIG. 3. Such gases require all-metal tubes and valves. The elastomeric hose is replaced by a metal tube 14, connected to an all-metal box 15 covered by a vacuum-tight flexible steel diaphragm 16. The orifice is formed inside box 15, between end of tube 14 leading to the vacuum pump and an elastomeric seal 17. As before, the purpose of the elastomeric seal is to absorb solid particles that would have prevented a metal-to-metal seal from closing. When cam 4 is at its highest position, the vacuum line is shut off. The operation is identical to FIG. 2. Parts 14, 15, 16 are typically made of stainless steel or have a corrosion resistant plating.

1-4. (canceled)

5. A throttle valve creating an equivalent of a small orifice by using a larger orifice and periodically squeezing the larger orifice to shut it off, creating a contaminant and particle resistant flow equivalent of the small orifice, and
making the larger orifice of an elastomeric material in order to achieve a self-cleaning action by squeezing the contaminants out when the larger orifice is shut off, or by allowing the contaminant particles to embed in the elastomeric material.

6. A valve as in claim 5 wherein the larger orifice is a hose made of natural rubber.

7. A valve as in claim 1 wherein the equivalent diameter of the small orifice is between 0.1 mm to 1 mm.

8. A valve as in claim 1 wherein the orifice is controlling the vacuum level during a sintering process.
